(19) United States
(12) Patent Application Publication
(10) Pub. No.: US 2012/0072207 A1
(43) Pub. Date: Mar. 22, 2012

(54) DOWN-MIXING DEVICE, ENCODER, AND METHOD THEREFOR

(75) Inventor: Toshiyuki Morii, Kanagawa (JP)

(73) Assignee: PANASONIC CORPORATION, Osaka (JP)

(21) Appl. No.: 13/322,732

(22) PCT Filed: Jun. 1, 2010
(86) PCT No.: PCT/JP2010/003665

§ 371 Date: Nov. 28, 2011

(30) Foreign Application Priority Data
Jun. 2, 2009 (JP) 2009-133308
Oct. 9, 2009 (JP) 2009-235409

(51) Int. Cl. G10L 19/00

(52) U.S. Cl. 704/201; 704/E19.001

(57) ABSTRACT

Provided are a down-mixing method and an encoder, wherein a high quantization performance can be realized when a balance adjustment operation due to a balance weight coefficient and a removal operation of a main component are combined. In the encoder (100), a down-mixing unit (101) generates a mono signal by multiplying an L-signal and an R-signal by coefficients a and ss, respectively, and summing the L-signal and the R-signal to generate a mono signal. A first encoding target signal, corresponding to the L-signal is generated by multiplying the mono signal by a balance weight coefficient wL and subtracting the same from the L-signal, using a multiplier (107) and an adder (109). A second encoding target signal, corresponding to the R-signal is generated by multiplying the mono signal by a balance weight coefficient wR and subtracting the same from the R-signal, using a multiplier (108) and an adder (110).

### TECHNICAL FIELD

The present invention relates to a down-mixing device, an encoder, and methods therefore.

### BACKGROUND ART

For effective use of transmission bands in mobile communication, compression encoding of digital information of speech or images is essential. Among them, in speech codec (encoding/decoding) technology that is widely used in cellular phones, there is an increasingly strong demand for conventional high-efficiency encoding with a high compression rate so as to acquire a better sound quality.

In addition, in recent years, standardization of a scalable codec having a multi-layer structure has been reviewed by International Telecommunication Union Telecommunication Standardization Sector (ITU-T) or Moving Picture Experts Group (MPEG), and a more effective high-quality speech codec is demanded. Furthermore, in recent years, speech codecs allows the setting of higher bit rates of 16 kbps to 32 kbps, and thus it has been demanded to satisfy the needs of that quality and the realistic sensation of (multiple channels and stereo audio) music.

As a system that encodes a stereo audio signal at a low bit rate, an intensity stereo system is known. In the intensity stereo system, a left channel signal (hereinafter, referred to as an “L signal”) and a right channel signal (hereinafter, referred to as an “R signal”) are generated by multiplying a monaural signal (hereinafter, referred to as an “M signal”) by scaling coefficients. Such a generation technique is also called amplitude panning.

According to the most basic technique of the amplitude panning, the L signal and the R signal are acquired by multiplying the M signal in the time domain by gain coefficients for amplitude panning (that is, balance weighting factors) (for example, Non-Patent Literature 1).

In addition, there is another technique in which the L signal and the R signal are acquired by multiplying each frequency component or each frequency group of the M signal by balance weighting factors (for example, Non-Patent Literature 2).

By encoding the balance weighting factors as encoding parameters of the parametric stereo, encoding a stereo signal can be realized (for example, Patent Literature 1 and Patent Literature 2). The balance weighting factor is described as a balance parameter in Patent Literature 1 and described as an ILD (level difference) in Patent Literature 2.

The idea of this intensity stereo applies to other encoding techniques and is widely used as a standard system “Advanced Audio Codec (AAC)” of MPEG-2 and MPEG-4 in ISO/IEC (for example, see Non-Patent Literature 3).

However, in the above-described conventional encoding techniques of audio signals, effective encoding is performed by using the following method. In other words, first, an M signal formed by down mixing is encoded by a core encoder. Then, a result acquired by multiplying a spectrum of the M signal after encoding, which is acquired by the core encoder, by a balance weighting factor is subtracted from the spectrum of the L signal and the spectrum of the R signal. Here, the intensity stereo technique is used, and by excluding the main components from the L signal and the R signal, the redundancy is sufficiently eliminated. Then, the L signal and the R signal from which the main components are excluded are further encoded.

In down mixing performed in the conventional technique of encoding audio signals, a process is used in which the average of the L signal and the R signal is acquired (in other words, a process of multiplying the sum of the L signal and the R signal by 0.5) is used. This averaging process is used in down mixing of most audio codecs including standard systems. In addition, conventionally, the reason for using the averaging process, which is the simplest integration process, in the down mixing, is that a monaural signal is not a simple intermediate signal but recognized as a target enjoyed by a user.

### CITATION LIST

### Patent Literature

PTL 1
Japanese Patent Application National Publication No. 2004-535145
PTL 2
Japanese Patent Application National Publication No. 2005-533271

### Non-Patent Literature

NPL 1
V. Pulkki and M. Karjalainen, “Localization of amplitude-panned virtual sources I: Stereophonic panning”, Journal of the Audio Engineering Society, Vol. 49, No. 9, September 2001, pp. 739-752
NPL 2
B. Cheng, C. Ritz and I. Burnett, “Principles and analysis of the squeezing approach to low bit rate spatial audio coding”, proc. IEEE ICASSP 2007, pp. I-13-I-16, April 2007
NPL 3
ISO/IEC 14496-3: 1999(E) “MPEG-2”, P 232, FIG. B.13

### SUMMARY OF INVENTION

### Technical Problem

However, as described above, in a case where the main component is eliminated by using a monaural signal that is formed through down mixing including the simple averaging process, there is a problem in that a sufficient quantization performance is not exhibited. The reason for this is that conventional down-mixing methods are not optimized for high-quality encoding of a stereo speech signal.

Accordingly, in order to further improve the sound quality, a down-mixing method is desired in which a high quantization performance is realized in a case where a balance adjusting process using the balance weighing factor and a process of eliminating a main component are combined.

An object of the present invention is to provide a down-mixing device, an encoder, and methods therefor that realize a high quantization performance in a case where a balance adjusting process using a balance weighing factor and a process of eliminating a main component are combined.

### Solution to Problem

According to the present invention, there is provided a down-mixing device that generates a monaural signal as an encoding target by using a first signal and a second signal that configure a stereo signal, the down-mixing device including: a first power calculating section that receives the first signal and second signal as inputs and calculates first power of the first signal and second power of the second signal; a first inner product calculating section that receives the first signal and the second signal as inputs and calculates a first inner product of the first signal and the second signal; a coefficient calculating section that calculates a first coefficient and a second coefficient, by which a first cost function is minimized, by repeating calculations using a first calculation equation that uses the first coefficient and the second coefficient by which the first signal and the second signal are multiplied, respectively so as to calculate the first power, the second power, the first inner product, and the monaural signal, the first calculation equation being acquired by modifying the first cost function that is configured by the sum of power of a first difference signal relating to the first signal and power of a second difference signal relating to the second signal; and a monaural signal calculating section that generates the monaural signal by adding results acquired by multiplying the first signal and the second signal by the first coefficient and the second coefficient, respectively.

According to the present invention, there is provided a down-mixing device that generates a monaural signal as an encoding target by using a first signal and a second signal that configure a stereo signal, the down-mixing device including: a monaural signal generating section that generates the monaural signal by using a result acquired by calculating a calculation equation that is set by using the sum of the product of elements of the first signal and the product of elements of the second signal.

According to the present invention, there is provided an encoder that encodes a first encoding target signal and a second encoding target signal generated so as to correspond to a first signal and a second signal that configure a stereo signal, and a monaural signal that is generated by using the first signal and the second signal, the encoder including: one of the above-described down-mixing device that generates the monaural signal by performing a down-mixing process using the first signal and the second signal; a monaural encoding section that generates a first code by encoding the monaural signal and generates a decoded monaural signal by decoding the first code; a weighting factor quantizing section that generates a first balance weighting factor used to generate the first encoding target signal and a second balance weighting factor used to generate the second encoding target signal by using the first signal, the second signal, and the decoded monaural signal; a first target generating section that generates the first encoding target signal by reducing the first signal by an amount of a result acquired by multiplying the decoded monaural signal by the first balance weighting factor; and a second target generating section that generates the second encoding target signal by reducing the second signal by an amount of a result acquired by multiplying the decoded monaural signal by the second balance weighting factor.

### Advantageous Effects of Invention

According to the present invention, a down-mixing device, an encoder, and methods therefor that realize a high quantization performance in a case where a balance adjusting process using a combination of a balance weighing factor and a process of eliminating a main component can be provided.

### BRIEF DESCRIPTION OF DRAWINGS

FIG. 1 is a block diagram illustrating the configuration of an encoder according to Embodiment 1 of the present invention.

FIG. 2 is a block diagram illustrating the configuration of a down-mixing section according to Embodiment 1 of the present invention.

FIG. 3 is a block diagram illustrating the configuration of a coefficient calculating section according to Embodiment 1 of the present invention.

FIG. 4 is a flowchart illustrating a method of generating a monaural signal by performing down-mixing in a down-mixing section according to an embodiment of the present invention.

FIG. 5 is a block diagram illustrating the configuration of a weighting factor quantizing section according to Embodiment 1 of the present invention.

FIG. 6 is a diagram illustrating a down-mixing method according to Embodiment 2 of the present invention.

FIG. 7 is a block diagram illustrating the configuration of a down-mixing section according to Embodiment 2 of the present invention.

FIG. 8 is a diagram illustrating an addition process performed by a matching section according to Embodiment 2 of the present invention.

### DESCRIPTION OF EMBODIMENTS

Hereinafter, embodiments of the present invention will be described in detail with reference to drawings.

### Embodiment 1

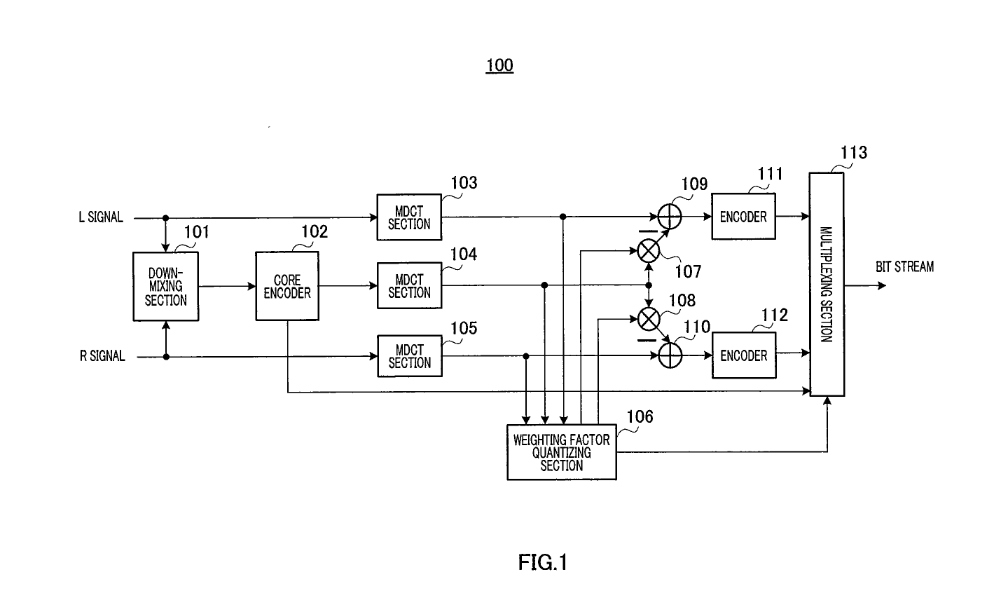

FIG. 1 is a block diagram illustrating the configuration of encoder 100 according to Embodiment 1 of the present invention. Encoder 100 encodes a stereo signal to be scalable (multi-layer structure) and encodes an M signal by using a core encoder and encodes the stereo signal in the frequency domain by using a decoded signal generated by further decoding the M signal. In addition, encoder 100 performs encoding and decoding by using a balance adjusting process (that is, panning) and a process of eliminating a main component. Since the present invention mainly relates to down mixing, the description of a decoder is omitted.

Encoder 100 receives a stereo signal as an input. A stereo signal is configured so as to enable the enjoyment of an audio having realistic sensations by putting different audio signals into the left ear and the right ear of a listener. Thus, in a case where the content is an audio signal, the simplest stereo signal is a two-channel signal of an L signal and an R signal.

Described in more detail, in FIG. 1, encoder 100 is mainly configured by: down-mixing section 101; core encoder 102; modified discrete cosine transform (hereinafter, referred to as an MDCT (Modified Discrete Cosine Transform)) sections 103, 104, and 105; weighing factor quantizing section 106; multiplication sections 107 and 108; adder sections 109 and 110; encoders 111 and 112; and multiplexing section 113.

Down-mixing section 101 receives an L signal and an R signal as inputs. Then, down-mixing section 101 performs down-mixing of the L signal and the R signal that have been input according to a “predetermined down-mixing method”, thereby acquiring an M signal. This “predetermined down-mixing method” and a detailed configuration of down-mixing section 101 will be described later in detail. Here, all the L signal, the R signal, and the M signal are represented as vectors.

Core encoder 102 encodes the M signal acquired by down-mixing section 101 and outputs an acquired encoding result to multiplexing section 113. In addition, core encoder 102 further decodes the encoding result. This decoding result (that is, a decoded M signal) is output to MDCT section 104. In addition, in a case where time domain encoding such as Code Excited Linear Prediction coding (CELP) is premised, down sampling may be performed before the encoding process, and up sampling may be performed after the decoding process.

MDCT section 103 receives an L signal as an input and transforms a signal in the time domain into a signal (frequency spectrum) in the frequency domain by performing a discrete cosine transformation of the input L signal. Then, MDCT section 103 outputs the signal (that is, the frequency domain L signal) after the transformation to weighting factor quantizing section 106 and adder section 109.

MDCT section 104 transforms a signal in the time domain into a signal (frequency spectrum) in the frequency domain by performing a discrete cosine transformation of the decoded M signal output from core encoder 102. Then, MDCT section 104 outputs the signal (that is, the frequency domain decoded M signal) after the transformation to weighting factor quantizing section 106, multiplication section 107, and multiplication section 108.

MDCT section 105 receives an R signal as an input and transforms a signal in the time domain into a signal (frequency spectrum) in the frequency domain by performing a discrete cosine transformation of the input R signal. Then, MDCT section 105 outputs the signal (that is, the frequency domain R signal) after the transformation to weighting factor quantizing section 106 and adder section 110.

Weighting factor quantizing section 106 calculates a balance weighting factor used for balance adjustment by using the frequency domain L signal output from MDCT section 103, the frequency domain decoded M signal output from MDCT section 104, and the frequency domain R signal output from MDCT section 105. In addition, weighting factor quantizing section 106 encodes the calculated balance weighting factor. The encoded balance weighting factor is output to multiplexing section 113. In addition, weighting factor quantizing section 106 decodes (that is, inverse quantization) the encoded balance weighting factor and, by using this, calculates inverse-quantization balance weighting factors (w_{L}, w_{R}). The inverse-quantization balance weighting factors (w_{L}, w_{R}) are output to multiplication sections 107 and 108, respectively. In addition, the detailed configuration of weighting factor quantizing section 106 will be described later in detail.

Multiplication section 107 outputs a multiplication result acquired by multiplying the frequency domain decoded M signal output from MDCT section 104 by the inverse-quantization balance weighting factor w_{L} output from weighting factor quantizing section 106 to adder section 109.

Multiplication section 108 outputs a multiplication result acquired by multiplying the frequency domain decoded M signal output from MDCT section 104 by the inverse-quantization balance weighting factor w_{R} output from weighting factor quantizing section 106 to adder section 110.

Adder section 109 generates an L signal (hereinafter, referred to as a “target L signal”) as a target for encoding by subtracting an amount of the multiplication result output from multiplication section 107, from the frequency domain L signal output from MDCT section 103.

Adder section 110 generates an R signal (hereinafter, referred to as a “target R signal”) as a target for encoding by subtracting the multiplication result output from multiplication section 108 from the frequency domain R signal output from MDCT section 105.

Hereinafter, for simplification, the frequency domain L signal, the frequency domain decoded M signal, and the frequency domain R signal may be simply referred to as the L signal, the decoded M signal, and the R signal. In addition, since the inverse-quantization balance weighting factors (w_{L}, w_{R}) may be calculated by performing inverse quantization of a balance weighting factor having a different notation and using the inversely-quantized balance weighting factor, hereinafter, the inverse-quantization balance weighting factors (w_{L}, w_{R}) are simply referred to as balance weighting factors (w_{L}, w_{R}).

The calculation performed by adder section 110 and adder section 109 described above is represented in the following equation 1.

(Equation 1)

\hat{L}_{f}=\hat{L}_{f}−w_{L}·\hat{M}_{f}

\hat{R}_{f}=R_{f}−w_{R}·\hat{M}_{f} [1]

Here, f: index

\hat{L}_{f}:target L signal

\hat{R}_{f}:target R signal

L_{f}:frequency domain L signal

R_{f}:frequency domain R signal

w_{L}, w_{R}:balance weighting factor

\hat{M}_{f}:frequency domain decoded M signal

The algorithm represented in equation 1 described above corresponds to a process of eliminating main components from the L signal and the R signal. The balance weighting factors represent the degree of similarity between the decoded M signal and the L signal and the degree of similarity between the decoded M signal and the R signal. Accordingly, in the target L signal and the target R signal acquired by subtracting results acquired by multiplying the balance weighting factors by the decoded M signal from the corresponding L signal and the corresponding R signal, the redundancies within the decoded M signal are omitted. As a result, the power of the target L signal and the power of the target R signal decrease, and accordingly, the target L signal and the target R signal can be encoded at a low bit rate with a high efficiency. However, the quantization target of the balance weighting factor can be acquired by using a method in which the power ratio between the L signal and the R signal is used or a method in which a correlation analysis for the L signal and the decoded M signal and a correlation analysis for the R signal and the decoded M signal are used. In addition, there is a method in which the balance weighting factor is quantized by acquiring a cost function without acquiring the quantization target.

Here, in order to effectively perform quantization, a restriction is added such that the addition of the two balance weighting factors results produces an integer. Here, this integer is 2.0, and w_{L}+w_{R}=2. Owing to this restriction, the balance weighting factor can be quantized by a small number of bits through scalar quantization.

Encoder 111 encodes the target L signal output from adder section 109 and outputs an acquired encoding result to multiplexing section 113.

Encoder 112 encodes the target R signal output from adder section 110 and outputs an acquired encoding result to multiplexing section 113.

Multiplexing section 113 multiplexes encoding results output from core encoder 102, weighting factor quantizing section 106, encoder 111, and encoder 112 and outputs a bit stream after the multiplexing. The bit stream after the multiplexing is transmitted to the reception side.

Next, the down-mixing method used in a down-mixing section 101 will be described in detail.

In this embodiment, the M signal is calculated by performing down mixing using a method represented in the following equation 2.

(Equation 2)

Mᵢ=α·Lᵢ+β·Rᵢ [2]

Here, α, β: down-mixing coefficients used for acquiring the M signal

Here, α and β are coefficients (hereinafter, referred to as down-mixing coefficients) by which the L signal and the R signal are multiplied for down mixing, and i is an index. The values of down-mixing coefficients α and β are determined such that a difference signal is a minimum in the balance adjusting process using the balance weighting coefficients (w_{L}, w_{R}) and the process of eliminating the main component that is performed in the latter stage of encoder 100. Apparently, since the M signal cannot be encoded before down mixing thereof, the values are determined under the assumption that the encoding distortion of the M signal is 0. Here, two balance weighting factors w_{I}, and w_{R} are represented by using one balance weighting factor w, and, by using the relation of w_{L}+w_{R}=2, it is set such that w_{L}=ω and w_{R}=2−ω. Based on the above-described condition, the cost function, as in the following equation 3, is represented as the sum of the power of a difference signal of the L signal and the power of a difference in signal of the R signal.

(Equation 3)

E=|L−ω·M|²+|R−(2−ω)·M|² [3]

Here, E: cost function
ω and 2-ω: balance weighting factors
L, R, and M: vectors of L signal, R signal, and M signal.

With that, down-mixing coefficients α and β in a case where the balance weighting factor ω is an ideal value are acquired.

First, by substituting equation 2 into equation 3, the following equation 4 is acquired.

(Equation 4)

E=|L−ωαL−ωβR|²+|(2−ω)αL+(1−2β+ωβ)R|² [4]

As can be understood from the cost function of equation 4, the balance weighting factor ω and the down-mixing coefficients α and β are multiplied together. Accordingly, the calculation of optimal values of the balance weighting factor and the down-mixing coefficients is performed by repeating an independent process for optimizing each value. Since both the balance weighting factor and the down-mixing coefficient are of the second order, there is an extreme value that relates to changes in all of the coefficients. Accordingly, through repetition of the calculation, the balance weighting factor and the down-mixing coefficients can be optimized.

Initially, both down-mixing coefficients α and β are set to 0.5 as initial values thereof.

First, when a partial derivative of the cost function of equation 4 with respect to balance weighting factor ω is taken, the following equation 5 is acquired.

$$\begin{matrix} ( Equation 5 ) & \\ \frac{\partial E}{\partial ω} = 2 \cdot ( {α}^{2} {\vert L \vert}^{2} + {β}^{2} {\vert R \vert}^{2} ) \cdot ω - L \cdot ( α L + β R ) + ( 2 α L + R - 2 β R ) \cdot ( - α L + β R ) & [ 5 ]\end{matrix}$$

Thus, when the left side of equation 5 is set to 0 so as to acquire an extreme value with respect to ω, balance weighting factor ω is represented by the following equation 6.

$$\begin{matrix}( Equation 6 ) & \\ ω = \frac{( 2 {α}^{2} + α ) {\vert L \vert}^{2} + ( 2 {β}^{2} - β ) {\vert R \vert}^{2} + ( - 4 α β + α + β ) ( LR )}{2 \cdot ( {α}^{2} {\vert L \vert}^{2} + {β}^{2} {\vert R \vert}^{2} )} & [ 6 ]\end{matrix}$$

Here, when both down-mixing coefficients α and β are substituted with 0.5 described above as the initial values, balance weighting factors ω (=w_{L}) and 2-ω (=w_{R}) are represented by the following equation 7.

$$\begin{matrix}( Equation 7 ) & \\ ω = \frac{2 \cdot {\vert L \vert}^{2}}{{\vert L \vert}^{2} + \vert {R}^{2} \vert} \\ 2 - ω = \frac{2 \cdot {\vert R \vert}^{2}}{{\vert L \vert}^{2} + {\vert R \vert}^{2}} & [ 7 ]\end{matrix}$$

As can be understood from equation 7, in a case where α and β are the initial values, the optimal balance weighting factors can be acquired by using power values.

Next, when a partial derivative of the cost function of equation 4 with respect to down-mixing coefficients α and β is taken, the following equation 8 is acquired.

$$\begin{matrix} ( Equation 8 ) & \\ \frac{\partial E}{\partial α} = \{ {ω}^{2} + {( 2 - ω )}^{2} \} \cdot α {\vert L \vert}^{2} + \{ {ω}^{2} - {( 2 - ω )}^{2} \} \cdot β ( LR ) - ω {\vert L \vert}^{2} + ( 2 - ω ) ( LR ) \\ \frac{\partial E}{\partial β} = \{ {ω}^{2} - {( 2 - ω )}^{2} \} \cdot α ( LR ) + \{ {ω}^{2} + {( 2 - ω )}^{2} \} \cdot β {\vert R \vert}^{2} - ω ( LR ) - ( 2 - ω ) {\vert R \vert}^{2} & [ 8 ]\end{matrix}$$

When the left sides of both equations represented in equation 8 are set to 0 so as to acquire extreme values with respect to α and β, simultaneous linear equations in two variables α and β are formed. These simultaneous linear equations in two variables can be simply solved by substituting ω represented in equation 7 therein and using the calculation of an inverse matrix by acquiring and substituting therein a power value of the L signal, a power value of the R signal, and an inner product of the L signal and the R signal. When the values of α and β acquired as above are substituted in equation 6, and the power value of the L signal, the power value of the R signal, and the inner product of the L signal and the R signal are substituted therein, a new value of ω can be acquired. Then, the new value of ω is substituted in the simultaneous linear equations of two variables α and β of which the left sides represented in equation 8 is set to 0, the power value of the L signal, the power value of the R signal, and the inner product of the L signal and the R signal are substituted therein, and the equations are solved, whereby new values of α and β can be acquired.

As above, ω and α and β are alternately acquired while they are alternately substituted, all the variables converge on optimal values. In other words, through this repeated calculation, the optimal down-mixing coefficients α and β can be acquired.

However, in an algorithm which is practically implemented, a scheme is necessary in which an upper limit value of the number of calculations is determined, and values calculated when the number of calculations reaches its upper limit are used as the optimal values, whereby the upper limit value of the amount of calculation is suppressed.

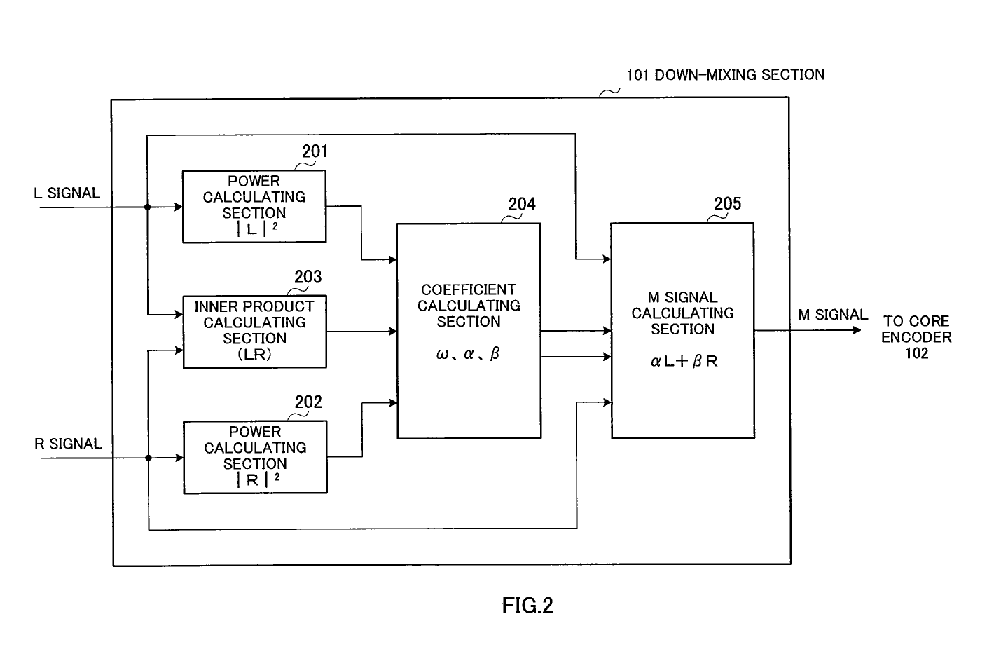

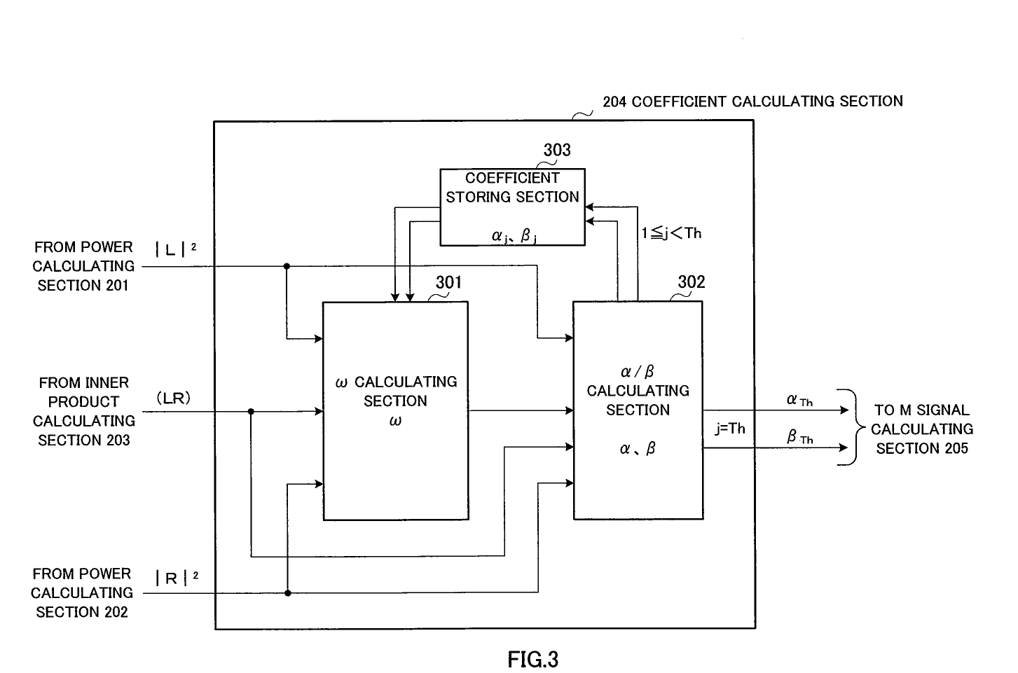

Next, an example of a specific configuration of down-mixing section 101 that performs the down-mixing method as described above will be described with reference to FIGS. 2 and 3.

FIG. 2 is a block diagram illustrating the internal configuration of down-mixing section 101 of encoder 100 illustrated in FIG. 1. Down-mixing section 101, mainly, is configured by power calculating sections 201 and 202, inner product calculating section 203, coefficient calculating section 204, and M signal calculating section 205.

Power calculating section 201 receives an L signal as an input and calculates the power |L|² of the L signal. Power calculating section 202 receives an R signal as an input and calculates the power |R|² of the R signal.

Inner product calculating section 203 receives an L signal and an R signal as inputs and calculates the inner product (LR) of the L signal and the R signal by taking the sum of the results acquired by multiplying the elements of the vectors.

Coefficient calculating section 204 calculates balance weighting factor ω and down-mixing coefficients α and β by using the power |L|² of the L signal that is calculated by power calculating section 201, the power |R|² of the R signal that is calculated by power calculating section 202, and the inner product (LR) of the L signal and the R signal that is calculated by inner product calculating section 203. The calculation method is as described above. A specific internal configuration of coefficient calculating section 204 will be described later.

M-signal calculating section 205 calculates an M signal by applying the L signal, the R signal, and α and β that are calculated by coefficient calculating section 204 to equation 2 and outputs the calculated M signal to core encoder 102.

FIG. 3 is a block diagram illustrating the internal configuration of coefficient calculating section 204 of down-mixing section 101 illustrated in FIG. 2. Coefficient calculating section 204 is configured by ω calculating section 301, α/β calculating section 302, and coefficient storing section 303. The above-described repeated calculation is performed by ω calculating section 301, α/β calculating section 302, and coefficient storing section 303, and the optimal values of ω, α, and β are finally calculated.

Here, ω calculating section 301 receives the power |L|² of the L signal that is calculated by power calculating section 201, the power |R|² of the R signal that is calculated by power calculating section 202, and the inner product (LR) of the L signal and the R signal that is calculated by inner product calculating section 203 as inputs, receives the values of α and β from coefficient storing section 303 as inputs, and calculates ω by applying these to equation 6.

In addition, α/β calculating section 302 receives the power |L|² of the L signal that is calculated by power calculating section 201, the power |R|² of the R signal that is calculated by power calculating section 202, and the inner product (LR) of the L signal and the R signal that is calculated by inner product calculating section 203 as inputs, receives the value of ω that is calculated by ω calculating section 301 as an input, and calculates α and β by applying these to the simultaneous linear equations in two variables α and β acquired by setting the left sides in equation 8 to 0 and solving the simultaneous linear equations. Since α and β acquired here are used for the above-described repeated calculation, the number of repetitions is denoted by j, and α and β are represented as αⱼ and βⱼ. As described above, since the upper limit value of the number of calculations is determined, and the values calculated, when the calculated number of calculations reaches the upper limit, need to be set as the optimal values, the upper limit value of repetitions here is set at j=Th.

Coefficient storing section 303 stores α₀ and β₀ in advance as initial values of α and β. In the above-described example, α₀=0.5 and β₀=0.5. In addition, coefficient storing section 303 receives the calculated values of αⱼ and βⱼ as inputs and stores the calculated values every time αⱼ and βⱼ are calculated in α/β storing section 302. In the storing method, the calculated values corresponding to the number of repetitions may be stored, or it may be configured such that the calculated values corresponding to the minimal number (for example, one time) are stored, and the stored values are sequentially updated every time αⱼ and βⱼ are calculated.

Here, α/β calculating section 302 outputs the values of αⱼ and βⱼ to coefficient storing section 303 as described above in a case where the number of repetitions is 1≦j<Th and outputs the values of α=α_{Th} and β=β_{Th} to M signal calculating section 205 in a case where the number of repetitions reaches the upper limit value j=Th. In addition, ω calculating section 301 fetches the values of αⱼ and βⱼ from coefficient storing section 303 and calculates the value of ω each time the values of αⱼ and βⱼ are stored in coefficient storing section 303.

M signal calculating section 205 receives an L signal and an R signal as inputs and receives down-mixing coefficients α and β calculated in coefficient calculating section 204 as inputs and, by applying these to equation 2, calculates a down-mixed M signal. This down-mixed M signal is output to core encoder 102.

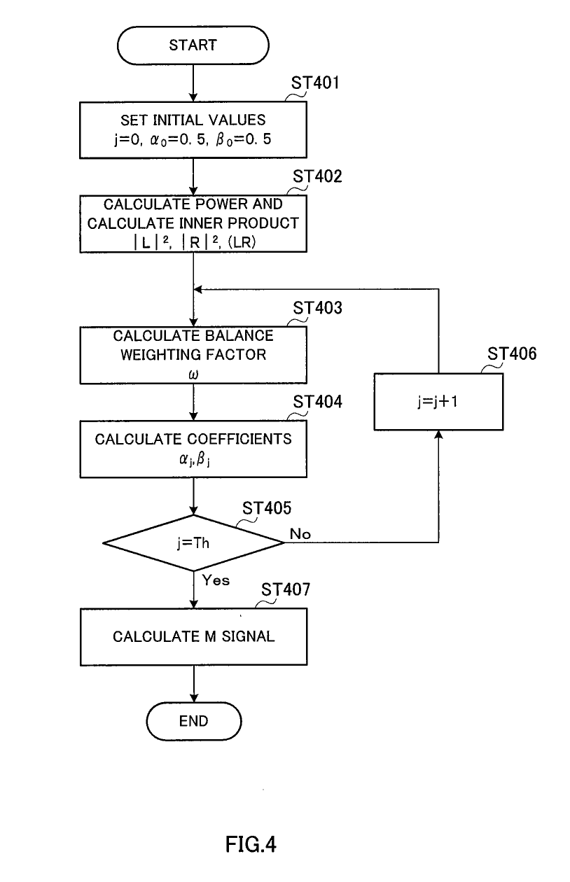

Next, the flow used for performing the above-described down-mixing method in down-mixing section 101 will be described with reference to FIG. 4.

FIG. 4 is a flowchart for generating a monaural signal by performing down-mixing in down-mixing section 101.

First, in down-mixing section 101, initially, j=0, α₀=0.5, and β₀=0.5 are set in coefficient storing section 303 in advance as initial setting (Step ST401).

Next, in power calculating sections 201 and 202 and the inner product calculating section 203, calculation of the power and calculation of the inner product are performed by using the L signal and the R signal that have been input, whereby the power |L|² of the L signal, the power |R|² of the R signal, and the inner product (LR) of the L signal and the R signal are calculated (Step ST402).

Next, ω calculating section 301 calculates the value of the balance weighting factor ω by applying the power |L|² of the L signal, the power |R|² of the R signal, and the inner product (LR) of the L signal and the R signal that are calculated in power calculating sections 201 and 202 and inner product calculating section 203 and the initial values α₀=0.5 and β₀=0.5 set in Step ST401 to equation 6 (Step ST403).

Next, in α/β calculating section 302, the power |L|² of the L signal, the power |R|² of the R signal, and the inner product (LR) of the L signal and the R signal that are calculated in power calculating sections 201 and 202 and inner product calculating section 203 and the value of ω calculated in Step ST403 are applied to the simultaneous linear equations in two variables α and β acquired by setting the left sides in equation 8 to 0, and the values of αⱼ and βⱼ are calculated by solving the simultaneous linear equations in two variables (Step ST404).

Next, in α/β calculating section 302, it is determined whether or not the number of calculations j of the repeated calculations is an upper limit value set in advance, in other words, j=Th (Step ST405). Then, in a case where the number of calculations j is 1≦j<Th (No in ST405), one is added to the value of the number of calculations j (Step ST406), and the flow is returned to ST403. On the other hand, in a case where the number of calculations reaches Th, in other words, j=Th (Yes in ST405), α=α_{Th} and β=β_{Th} are regarded as the optimal values and are output to M signal calculating section 205.

Next, in M signal calculating section 205, the L signal and the R signal and α=α_{Th} and β=β_{Th} calculated in ST404 are applied to equation 2, whereby a monaural signal (M signal) is calculated (Step ST407).

The down-mixing method for generating the M signal by using the L signal and the R signal, according to the present invention, has been described as above.

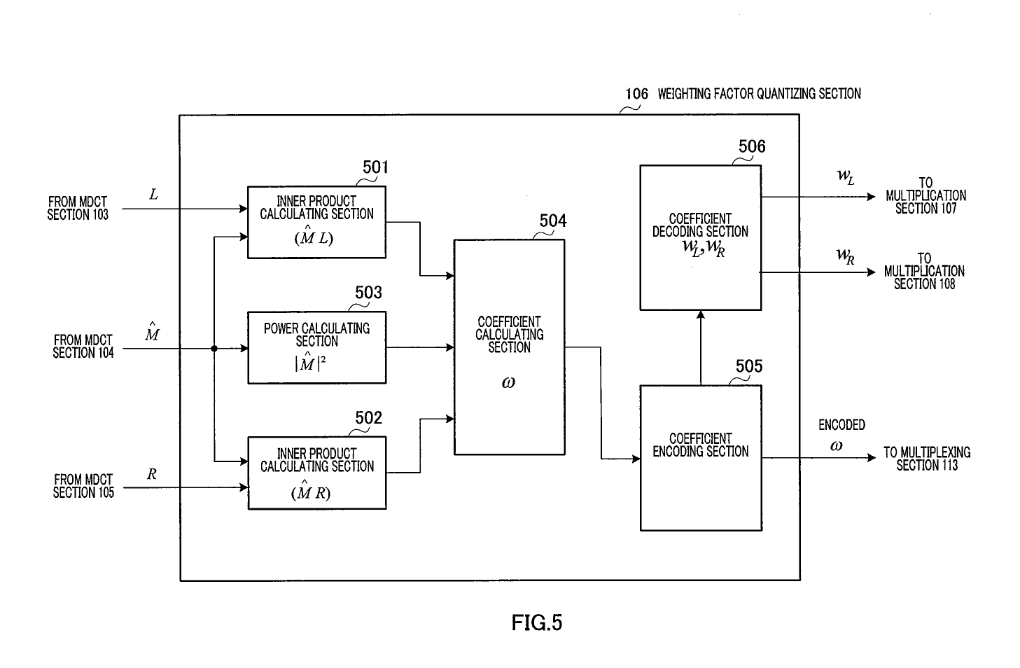

Next, an example of the specific configuration of weighting factor quantizing section 106 will be described with reference to FIG. 5.

FIG. 5 is a block diagram illustrating the internal configuration of weighting factor quantizing section 106 of encoder 100 illustrated in FIG. 1. Weighting factor quantizing section 106 is mainly configured by inner product calculating sections 501 and 502, power calculating section 503, coefficient calculating section 504, coefficient encoding section 505, and coefficient decoding section 506.

Inner product calculating section 501 receives a frequency domain L signal and a decoded M signal output from MDCT sections 103 and 104 as inputs and calculates the inner product (MAL) of the L signal and the M signal by taking the sum of the results acquired by multiplying the elements of the vectors.

Inner product calculating section 502 receives a frequency domain R signal and a decoded M signal output from MDCT sections 105 and 104 as inputs and calculates the inner product (M̂R) of the R signal and the M signal by taking the sum of the results acquired by multiplying the elements of the vectors.

Power calculating section 503 receives a frequency domain M signal output from MDCT section 104 as an input and calculates the power |M̂|² of the M signal.

Coefficient calculating section 504 accepts input of the inner product (M̂L) of the L signal and the M signal and the inner product (M̂R) of the R signal and the M signal, which are calculated by inner calculating sections 501 and 502, and the power |M̂|² of the M signal that is calculated by power calculating section 503 and, calculates balance weighting factor ω using the input values. The method of calculating balance weighting factor ω used here will be described later.

Coefficient encoding section 505 encodes balance weighting factor ω calculated by coefficient calculating section 504. The encoded balance weighting factor (that is, a code relating to the balance weighting factor) is output to multiplexing section 113 and coefficient decoding section 506.

Coefficient decoding section 506 decodes (that is, inverse quantization) the balance weighting factor encoded by coefficient encoding section 505 and generates inverse-quantized balance weighting factor ω′. As described above, based on the relation of w_{L}+w_{R}=2, since it can be represented that w_{L}=ω′ and w_{R}=2−ω′, coefficient decoding section 506 calculates two balance weighting factors w_{L} and w_{R} by using the inverse-quantized balance weighting factor ω′.

The calculated balance weighting factors w_{L} and w_{R} are output to multiplication sections 107 and 108 and are used for the balance adjusting process and the process of eliminating a main component.

Here, the method of calculating balance weighting factor ω in coefficient calculating section 504 will be briefly described. Similarly to the method of calculating the balance weighting factor in down-mixing section 101, in the method of calculating balance weighting factor ω, balance weighting factor ω is determined such that the cost function E is a minimum.

First, the cost function E can be represented similarly to equation 3. However, the L signal, the R signal, and the M signal input to weighting factor quantizing section 106 are signals after the frequency transformation. In addition, since the M signal is the decoded M signal, by substituting M used in equation 2 with M̂, the cost function E, as in the following equation 9, is given as the sum of the power of a difference signal of the L signal and the power of a difference signal of the R signal.

(Equation 9)

E=|L−ω·\hat{M}|²+|R−(2−ω)·\hat{M}² [9]

In equation 9, when a partial derivative of equation 9 with respect to the balance weighting factor ω is taken, the following equation 10 can be acquired.

$$\begin{matrix}( Equation 10 ) & \\ \frac{\partial E}{\partial ω} = r {\vert \hat{M} \vert}^{2} ω - 2 ( \hat{M} L ) + 2 ( \hat{M} R ) - 4 {\vert \hat{M} \vert}^{2} & [ 10 ]\end{matrix}$$

Accordingly, by setting the left side of equation 10 to 0, the balance weighting factor ω is represented by the following equation 11.

$$\begin{matrix}( Equation 11 ) & \\ ω = \frac{( \hat{M} L ) - ( \hat{M} R )}{2 {\vert \hat{M} \vert}^{2}} + 1 & [ 11 ]\end{matrix}$$

Accordingly, by applying the inner product (MAL) of the L signal and the M signal and the inner product (M̂R) of the R signal and the M signal, which are calculated by inner calculating sections 501 and 502, and the power |M̂|² of the M signal that is calculated by power calculating section 503 to equation 11, optimal balance weighting factor ω can be calculated.

As above, according to the down-mixing method and the configuration of the encoder in which the balance adjusting process according to the balance weighting factors and the process of eliminating the main component are combined, the optimal coefficients are set, whereby a high quantization performance can be realized.

However, in a case where the values of down-mixing coefficients α and β steeply change in each vector, there is a possibility that the acquired M signal is a discontinuous sound, and accordingly, smoothing may be performed for α and β. Through this process, the acquired M signal can be suppressed from being a discontinuous signal. For example, as this smoothing method, smoothing can be performed by using the following equation 12 by using calculated α and β. Then, α̂ and β̂ acquired by using equation 12 can be used for down-mixing.

(Equation 12)

\hat{α}=α*η+\hat{α}*(1−η)

\hat{β}=β*η+\hat{β}*(1−η) [12]

Here, α̂, β̂: smoothed down-mixing coefficients (coefficients used in the previous frame) and η: acceleration coefficient.

In order to acquire the smoothing effect, it is preferable that the above-described acceleration coefficient η is a constant of about 0.1 to 0.3. In addition, instead of setting this acceleration coefficient to a constant, there is a method in which the acceleration coefficient is changed in accordance with the variations in the down-mixing coefficients α and β. In other words, in a case where there are large variations in α and β, the acceleration coefficient η is decreased, and, in contrast to this, in a case where there are small variations in α and β, the acceleration coefficient η is increased. Through this, while the smoothing effect is acquired, in a case where there are small variations, optimization can be performed in a speedy manner. Even when a method is used for smoothing in which the variation amounts of α and β are constant, similar advantages can be acquired.

In addition, smoothing may be performed while performing down-mixing. This can be realized by an algorithm represented in the following Equation 13.

$$\begin{matrix}( Equation 13 ) & \\ for i = 0 to N \\ \{ \\ {M}_{i} = \hat{α} {L}_{i} + \hat{β} {R}_{i} \\ \hat{α} = α * λ + \hat{α} * ( 1 - λ ) \\ \hat{β} = β * λ + \hat{β} * ( 1 - λ ) \\ \} & [ 13 ]\end{matrix}$$

Here, N is a vector length of a signal.

An acceleration coefficient λ used in equation 13 may be smaller than the acceleration coefficient η used in equation 12, and, more specifically, with an acceleration coefficient λ of about 0.01 to 0.05, sufficient smoothing performance can be acquired.

In addition, although only α and β may remain as variables by substituting ω represented in equation 6 into Equation 8, the equations are too complicated (in other words, in a fractional expression, the denominator and the numerator are of a high order), whereby causing it to be difficult to solve the equations. In contrast to this, in the method described in this embodiment, although sequential calculations are necessary, there is an advantage in that the solution can be acquired without using a complicated calculation.

An M signal is acquired by performing down-mixing of α and β or α̂ or β̂ acquired as described above by using equation 2. According to this method, the following advantages can be acquired. In other words, first, down-mixing can be performed on the premise of the balance adjusting process and the process of eliminating the main component. Second, since the sum of the power of the L signal and the power of the R signal after the elimination of the main component can be minimized, the encoding performance can be improved, and, as a result, a much better sound quality can be acquired. Third, by restricting the sum of the balance weighting factors, the value of scaling that is necessary is included in the M signal at the time of down-mixing. As a result, only w that is one of the balance weighting factor may be encoded without considering the decoded M signal, and accordingly, quantization at a small number of bits can be performed.

Here, as a comparative technique, a conventional down-mixing method will be briefly described. In the conventional down-mixing, an M signal is acquired by using the following equation 14.

(Equation 14)

Mᵢ=(Lᵢ+Rᵢ)·0.5 [14]

Here, i: index, Lᵢ: L signal, Rᵢ: R signal, and Mᵢ: M signal.

When this conventional down-mixing method and the down-mixing method described in this embodiment are compared, qualitatively, the effect of the power of the L signal and the R signal on the weighting factor is larger in the down-mixing method of this embodiment than in the conventional down-mixing method in which an average is taken by fixing the weighing factor (down-mixing coefficient) to 0.5 in advance. In other words, as can be understood from equation 8, the down-mixing coefficient of a signal having a high power tends to be increased. As the ratio of a signal component having a high power to the M signal increases, more bits are distributed to the component. As a result, the error of the signal having higher power decreases, and, consequently, the sum of errors decreases.

In addition, in a case where there is a restriction that the sum of two balance weighing factors is a constant, which is similar to the down-mixing method described in this embodiment, in the above-described conventional down-mixing method, the encoding performance of the conventional down-mixing method is low, and accordingly, the quantization of a scaling component is necessary. However, in the down-mixing method described in this embodiment, as described above, it is an advantageous that the quantization of a scaling component is not necessary.

As above, according to this embodiment, in encoder 100 that receives an L signal and an R signal, which configure a stereo signal, as inputs, down-mixing section 101 generates a monaural signal (M signal) by adding multiplication results acquired by multiplying the L signal and the R signal by coefficients α and β. Then, by using multiplication section 107 and adder section 109, a value acquired by multiplying the monaural signal by the balance weighting factor w_{I}, is subtracted from the L signal so as to generate a target L signal as a first encoding target signal corresponding to the L signal, and, similarly, by using multiplication section 108 and adder section 110, a value acquired by multiplying the monaural signal by the balance weighting factor w_{R} is subtracted from the R signal so as to generate a target R signal as a second encoding target signal corresponding to the R signal. The down-mixing coefficients α and β together with the balance weighting factors w_{L} and w_{R} are calculated so as to minimize a cost function E represented in the following equation 15.

(Equation 15)

E=|L−w_{L}·M|²+|²+|R−w_{R}·M|² [15]

Here, E is the cost function, L is the L signal, R is the R signal, and M is the monaural signal.

Accordingly, coefficients are set such that the coefficients are optimal in a case where the balance adjusting process using the balance weighting factors and the process of eliminating the main component are combined together, and accordingly, an encoder realizing a high quantization performance can be achieved.

### Embodiment 2

In Embodiment 2, a configuration is employed in which encoding and decoding are performed by using balance adjustment and main component eliminating process, and, in the configuration, a method disclosed in Non-Patent Literature 3 (P232, FIG. B.13) can be performed with higher precision. The main configuration of an encoder according to Embodiment 2 is similar to that of Embodiment 1, and the description will be presented with reference to FIG. 1. Since this embodiment, similarly to Embodiment 1, relates only to down-mixing, the description of a decoder will be omitted.

Down-mixing section 101 of encoder 100 according to Embodiment 2 performs the down-mixing of an L signal and an R signal that have been input according to a “predetermined down-mixing method”, thereby acquiring an M signal. However, in the “predetermined down-mixing method” of Embodiment 2, differently from Embodiment 1, the M signal is acquired by solving plural linear equations that have the sum of results acquired by multiplying L signals together and multiplying R signals together as a basic element. This “predetermined down-mixing method” and a detailed configuration of down-mixing section 101 will be described later in detail.

The process of core encoder 102 to adder sections 109 and 110 is basically the same as that of Embodiment 1, and the description thereof will be omitted. However, although there is the restriction (w_{L}+w_{R}=2, w_{L}=ω, and w_{R}=2−ω) that the addition of two weighting factors results in 2.0 for performing effective quantization in Embodiment 1, in order to perform the analysis by increasing the degree of freedom in Embodiment 2, there are no restrictions on the magnitudes of the balance weighting factors.

Next, the down-mixing method used in down-mixing section 101 will be described in detail.

First, a down-mixing algorithm of Embodiment 2 will be described. This algorithm can be used in a case where an inverse matrix can be calculated with high accuracy. According to this algorithm, relating to the M signal, a solution that is more general than that of Embodiment 1 can be acquired, and the solution is theoretically optimal in a case where balance adjustment and main component eliminating process are premised.

First, an error (that is, a cost function) according to the balance adjustment and the main component eliminating process is represented as the following equation 16 based on an M signal before encoding and balance weighting factors.

(Equation 16)

E=|L−ω_{L}·M|²+|R−ω_{R}·M|² [16]

ω_{L}, ω_{R}: balance weighting factors

Here, the balance weighting factor ω_{L} (=w_{L}) and ω_{R} (=w_{R}) are independent from each other and have no restriction on the values thereof, and the power (that is, |M|²) of the M signal is 1. Under these conditions, by taking a partial derivative of the cost function (distortion function) illustrated in equation 16 with respect to both balance weighting factors ω_{L} and ω_{R}, two factors are acquired. The calculation method is as illustrated in equation 17.

$$\begin{matrix}( Equation 17 ) & \\ \begin{matrix}\frac{\partial E}{\partial {ω}_{L}} = - ( L - {ω}_{L} ) \cdot M = 0 & {ω}_{L} = \frac{L \cdot M}{{\vert M \vert}^{2}} = L \cdot M \\ \frac{\partial E}{\partial {ω}_{R}} = - ( R - {ω}_{R} ) \cdot M = 0 & {ω}_{R} = \frac{R \cdot M}{{\vert M \vert}^{2}} = R \cdot M\end{matrix} \} & [ 17 ]\end{matrix}$$

By substituting the balance weighting factors ω_{L} and ω_{R} acquired in equation 17 into the cost function of equation 16, the following equation 18 is acquired. In addition, i is an index.

$$\begin{matrix}( Equation 18 ) & \\ \begin{matrix}E = {\vert L - ( L \cdot M ) \cdot M \vert}^{2} + {\vert R - ( L \cdot M ) \cdot M \vert}^{2} \\ = {\vert L \vert}^{2} + {\vert R \vert}^{2} - {( L \cdot M )}^{2} - {( R \cdot M )}^{2} \\ = {\sum }_{i = 0}^{N - 1} {L}_{i} \cdot {L}_{i} + {\sum }_{i = 0}^{N - 1} {R}_{i} \cdot {R}_{i} - {( {\sum }_{i = 0}^{N - 1} {L}_{i} \cdot {M}_{i} )}^{2} - {( {\sum }_{i = 0}^{N - 1} {R}_{i} \cdot {M}_{i} )}^{2}\end{matrix} & [ 18 ]\end{matrix}$$

Lᵢ, Rᵢ: L signal, R signal

i: index (i=0 to N−1, N is a vector length of a signal)

In order to acquire the M signal, by taking a partial derivative of the cost function of equation 18 with respect to the element of the M signal, the following equation 19 is acquired.

In addition, I is an index of a monaural signal for which a partial derivative is taken.

$$\begin{matrix}( Equation 19 ) & \\ \begin{matrix}\frac{\partial E}{- 2.0 \cdot \partial {M}_{I}} = ( {\sum }_{i = 0}^{N - 1} {L}_{i} \cdot {M}_{i} ) \cdot {L}_{I} + ( {\sum }_{i = 0}^{N - 1} {R}_{i} \cdot {M}_{i} ) \cdot {R}_{I} \\ = {\sum }_{i = 0}^{N - 1} ( {L}_{i} \cdot {L}_{I} + {R}_{i} \cdot {R}_{I} ) \cdot {M}_{i} = 0 ( for all I )\end{matrix} & [ 19 ]\end{matrix}$$

I: index of monaural signal for which a partial derivative is taken (0≦I≦N−1)

Here, since equation 19 described above has indefinite solutions, it is unlikely to be solved at a glance.

However, although there is the condition of that |M|²=1 in the M signal, equation 19 does not depend on the vector magnitude of the M signal, and thus one element can be arbitrarily fixed. Thus, it is assumed that M₀=1. Accordingly, based on equation 19, the following equation 20 is acquired.

$$\begin{matrix} ( Equation 20 ) & \\ \frac{\partial E}{- 2.0 \cdot \partial {M}_{I}} = {\sum }_{i = 1} ( {L}_{i} \cdot {L}_{I} + {R}_{i} \cdot {R}_{I} ) \cdot {M}_{i} + {L}_{0} \cdot {L}_{I} + {R}_{0} \cdot {R}_{I} = 0 ( for all I ) \\ ∴ {\sum }_{i = 1} ( {L}_{i} \cdot {L}_{I} + {R}_{i} \cdot {R}_{I} ) \cdot {M}_{i} = - ( {L}_{0} \cdot {L}_{I} + {R}_{0} \cdot {R}_{I} ) ( for all I ) & [ 20 ]\end{matrix}$$

Thus, by solving the simultaneous plural linear equations illustrated in equation 20, the vector of the M signal of which the power and the polarity are not determined can be acquired. More specifically, an inverse matrix of a square matrix that has the sum of a term Lᵢ·L_{I} acquired by multiplying the L signals together and a term Rᵢ·R_{I} acquired by multiplying the R signals together as its element in equation 20 is acquired. By multiplying the right side in equation 20 with the inverse matrix, the vector of the M signal can be acquired. Then, by performing a normalization of the power in the order of the following equations 21 and 22, the M signal can be acquired. In addition, j is an index.

$$\begin{matrix}( Equation 21 ) & \\ Pow = \sqrt{{\sum }_{j} {M}_{j}^{2}} \\ {m}_{i} = \frac{{M}_{i}}{Pow} & [ 21 ]\end{matrix}$$

Pow: power of monaural signal (amplitude as a vector)

j: index

mᵢ: normalization of power (adjust the amplitude as a vector to 1)

(Equation 22)

Mᵢ=mᵢ [22]

According to the above-described algorithm, the shape of a monaural signal having the power of “1.0” can be acquired. In addition, in the description presented above, although it is assumed that M₀=1 when i is fixed as i=0, i may be fixed to another value. For example, in a case where i is fixed as i=2, M₂=1, and equation 20 is a series starting from 0 from which the second item is extracted.

Then, finally, by adjusting the power and the polarity of the monaural signal in the following sequence, the monaural signal that is practically used is acquired. In Embodiment 2, adjustments of the power and the polarity are performed such that a difference between each one of the L signal and the R signal and the M signal, of which the power is adjusted, becomes the minimum. In other words, a coefficient a, for which the cost function F of the following equation 23 is the minimum, may be acquired.

(Equation 23)

F=|L−aM|²+|R−aM|² [23]

F: cost function

Accordingly, since the result of taking a partial derivative of equation 23 with respect to the coefficient a is 0, the coefficient a is acquired by using equation 24.

$$\begin{matrix}( Equation 24 ) & \\ a = \frac{( L + R ) \cdot M}{2} & [ 24 ]\end{matrix}$$

By using this coefficient a, in the order of the following equations 25 and 26, the final monaural signal M is acquired.

(Equation 25)

nᵢ=aMᵢ [25]

nᵢ: vector as a center value

(Equation 26)

Mᵢ′=nᵢ [26]

Mᵢ′: monaural signal multiplied by a (rewritten into the same memory)

The down-mixing algorithm of Embodiment 2 has been described as above.

Next, a method of performing down-mixing using this algorithm will be described.

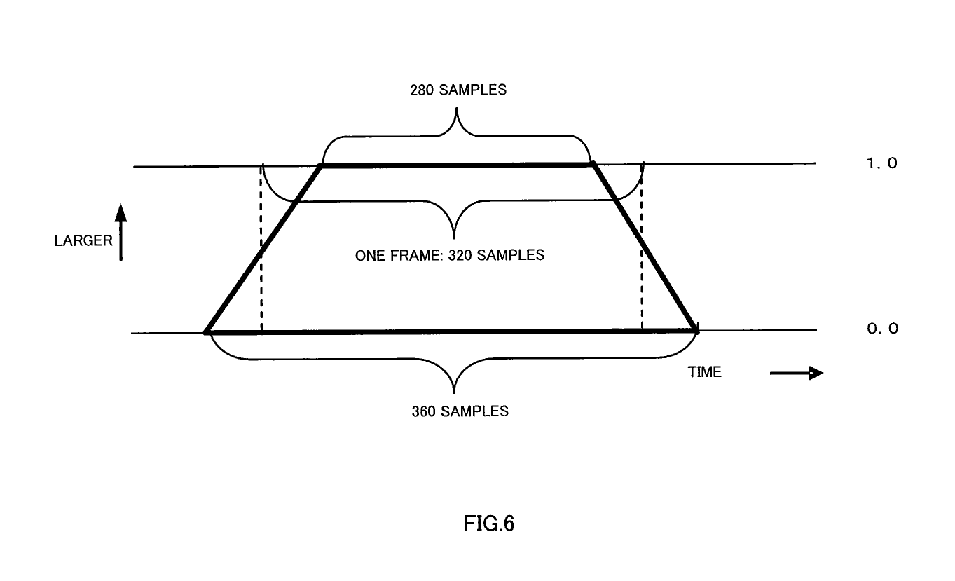

Here, in order to secure the continuity of the monaural signal (in other words, in order not to cause the feeling of a different sound in a connecting portion between monaural signals adjacent to each other), the M signal is matched by using a matching window. For example, in a case where 320 samples of M signals are fetched from 320 samples of the L signals and the R signals, for example, the monaural signals are calculated from each 20 samples before and after the above-described samples set as a margin. More specifically, a matching window (hereinafter referred to as a trapezoidal window) having a trapezoidal shape as illustrated in FIG. 6 is multiplied on the L signals and the R signals clipped ranging from the start of 20 samples preceding to a processing target frame to the end of 20 samples subsequent to the processing target frame. In FIG. 6, a case where one frame corresponds to 320 samples is illustrated, and, in this case, the clipped L signals and R signals are processed as the signals of 360 samples.

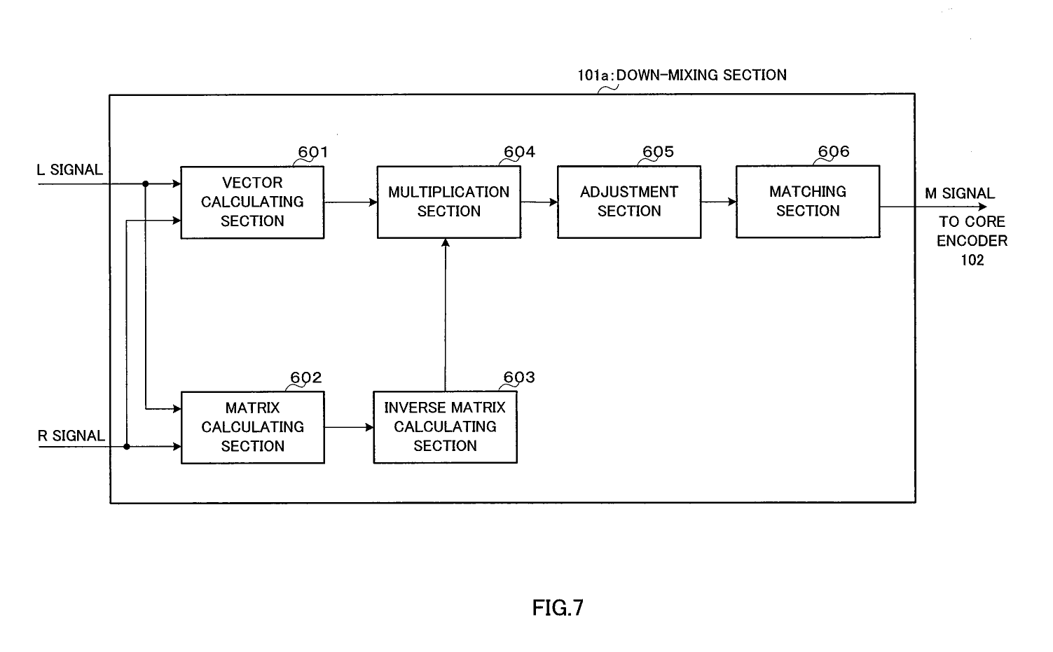

Next, an example of a specific configuration of down-mixing section 101a that performs the down-mixing method as described above will be described with reference to FIG. 7. In encoder 100 illustrated in FIG. 1, down-mixing section 101a has an internal configuration that is different from that of down-mixing section 101 of Embodiment 1.

FIG. 7 is a block diagram illustrating the internal configuration of down-mixing section 101a of encoder 100 according to Embodiment 2. Down-mixing section 101a, mainly, is configured by vector calculating section 601, matrix calculating section 602, inverse matrix calculating section 603, multiplication section 604, adjustment section 605, and matching section 606.

Vector calculating section 601 acquires the vector on the right side in equation 20 as equation 27 by using the samples of the clipped L signals and R signals.

(Equation 27)

{L₀·L_{I}+R₀·R_{I}} [27]

I=1˜360

Matrix calculating section 602 acquires the matrix (square matrix) on the left side of equation 20 as equation 28 by using the samples of the clipped L signals and R signals.

(Equation 28)

{Lᵢ·L_{I}+Rᵢ·R_{I}} [28]

i=1˜360, I=1˜360

Then, inverse matrix calculating section 603 acquires an inverse matrix of the matrix illustrated in equation 28. Since this matrix is a square matrix, an inverse matrix can be acquired by using a general algorithm (for example, a “maximum pivot method” or the like).

Multiplication section 604 calculates the vector of the M signal, of which the power and the polarity are not determined, by multiplying the inverse matrix acquired by inverse matrix calculating section 603 by the vector acquired by vector calculating section 601. In other words, vector calculating section 601, matrix calculating section 602, inverse matrix calculating section 603, and multiplication section 604 serve as a section that calculates an M signal vector.

Adjustment section 605 performs the adjustment (that is, the adjustment illustrated in equations 21 and 22 of power and the adjustment of the power and the polarity (that is, the adjustment illustrated in equations 24, 25, and 26, whereby acquiring an M signal.

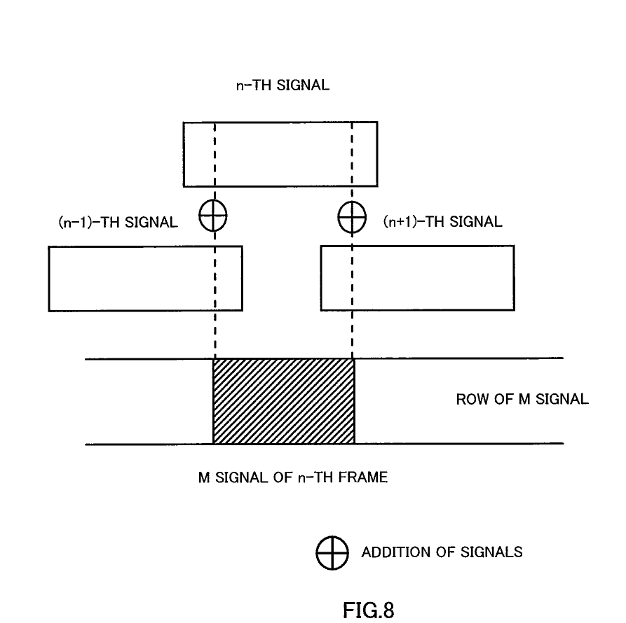

Matching section 606 repeatedly adds a plurality of clipped M signals acquired by adjustment section 605, thereby acquiring an M signal row. FIG. 8 is a diagram illustrating the appearance of an addition process in matching section 606.

In FIG. 6, since the L signals and the R signals are initially clipped in a trapezoidal shape, matching section 606 directly adds a plurality of M signals acquired by adjustment section 605 repeatedly. The length of the M signal acquired by adjustment section 605 corresponds to the 360 samples, and the length of the portions that are repeatedly added by matching section 606 is 40 samples before and after the samples. Accordingly, the M signals (a portion denoted by broken lines in FIG. 8) corresponding to one frame (=320 samples) can be acquired in the row of the M signals. The detailed description of down-mixing section 101a has been presented as above.

In addition, in the description presented above, although matching is performed by using a trapezoidal window, a sine window, a triangular window, or the like may be used instead of the trapezoidal window. The reason for this is that the present invention does not depend on the shape of the window. However, as the length of the overlapping portion increases, the delay time increases. Accordingly, the caution is needed.

By applying down-mixing section 101a acquired as above to down-mixing section 101 of encoder 100 illustrated in FIG. 1, the redundancy can be excluded further based on a difference of the decoded M signals using the balance weighting factors, and accordingly, more effective encoding can be performed.

In addition, although the condition that w_{L}+w_{R}=2, that is, the sum of the balance weighting factors is 2, is set in Embodiment 1, this condition is not set in this embodiment. However, although the condition of the weighting factor at the time of down-mixing is different, actually, even in a case where down-mixing section 101a of this embodiment is applied, a tendency that the sum of the balance weighting factors is a value close to 2 is checked. Accordingly, in this embodiment, even in a case where an effective method of encoding the weighting factor (encoding of the weighting factor with a small number of bits) is selected, and down-mixing section 101a is applied to down-mixing section 101, the configuration of weighting factor quantizing section 106 of encoder 100 illustrated in FIG. 1 is the same as a conventional configuration or that of Embodiment 1. It is apparent that a weighting factor quantizing section having a configuration that is optimized for the configuration of down-mixing section 101a according to this embodiment may be set and applied.

As above, according to this embodiment, by using the L signal (first signal) and the R signal (second signal) that configure a stereo signal, a monaural signal is generated by using a calculation result of a calculation equation that is set by using the sum of the product of first signal elements and the product of second signal elements in a down-mixing device (down-mixing section 101a) that generates a monaural signal as an encoding target.

More specifically, the down mixing device (down-mixing section 101a) of this embodiment includes: a vector calculating section (vector calculating section 601) that calculates a third signal having the sum of the product of an element of a fixed number of the first signal and an element of the first number of the first signal and the product of an element of the fixed number of the second signal and an element of the first number of the second signal as its element; a matrix calculating section (matrix calculating section 602) that calculates a matrix having the sum of the product of an element of a second number of the first signal and an element of the first number of the first signal and the product of an element of the second number of the second signal and an element of the first number of the second signal as its element; an inverse matrix calculating section (inverse matrix calculating section 603) that calculates an inverse matrix of the above-described matrix; and an multiplication section that generates a monaural signal by using a result acquired by multiplying the inverse matrix and the third signal together.

### Other Embodiments

(1) In each embodiment described above, a scalable configuration has been described as an example in which a monaural signal is encoded by the core encoder before encoding a stereo signal. However, the present invention is not limited thereto and may be applied to an encoder that does not include the core encoder and encodes a stereo signal as well.

(2) In each embodiment described above, as the monaural signal that is handled by weighting factor quantizing section 106, although a decoded monaural signal is used, the present invention is not limited thereto, and a “down-mixed monaural signal” may be used.

(3) In Embodiment 1, although a case has been described in which the sum of the balance weighting factors of L and R is fixed to 2.0, it is apparent that this numeric value may be any other numeric value. For example, in a case where the sum of the balance weighting factors of L and R is set to 1.0, a value that is half of that of a case where the balance weighting factor is set to 2.0 is acquired, only the magnitude of the M signal is doubled, and, by making the corresponding adjustments to the encoder and the decoder, it is apparent that the exact same performance can be acquired.

(4) In each embodiment described above, although down-mixing is performed in the time domain, the present invention is not limited thereto, and down-mixing may be performed in the frequency domain and the result thereof may be transformed into the time domain. The reason for this is that the present invention is not dependent on the domain in which down-mixing is performed.

(5) In each embodiment described above, as a transformation method into the frequency domain, although the MDCT is used, the present invention is not limited thereto, and any system such as a “Discrete Cosine Transform (DCT)” or a “Fast Fourier Transform (FFT)” may be used as long as it is a digital transformation system similar thereto. The reason for this is that the present invention does not depend on the frequency transformation method.

(6) In each embodiment described above, signals input to encoder 100 are described as the L signal and the R signal that are signals in the frequency domain. However, the present invention is not limited thereto, and a first signal and a second signal that are input signals input to encoder 100 and configure a stereo signal may be signals of the time domain, signals of the frequency domain, or signals in a subinterval thereof. The reason for this is that the present invention does not depend on the property of the input signals.

(7) The codes acquired in each embodiment described above are transmitted in a case where they are used for communication and are stored on a recording medium (a memory, a disc, a printing code, or the like) in a case where they are used for storage. The present invention does not depend on the method of using the codes.

(8) In each embodiment described above, although the case of two channels has been described, it is apparent that the present invention is effective also for a case of multi-channels such as 5.1 channels or the like.

(9) In each embodiment described above, although a case has been described in which the present invention is configured by hardware, the present invention can be realized by software.

In addition, each functional block used in the description of each embodiment described above is typically realized by an LSI that is an integrated circuit. These may be individually formed as one chip, or some or all of them may be included in one chip. Although the LSI is described here, based on a difference in the degree of integration, it may be called an IC, a system LSI, a super LSI, or an ultra LSI.

In addition, the technique for forming an integrated circuit is not limited to LSI, and the integrated circuit may be realized by a dedicated circuit or a general-purpose processor. Furthermore, an Field Programmable Gate Array (FPGA) that is programmable after manufacturing the LSI or a reconfigurable processor in which the connection or the setting of circuit cells inside the LSI can be reconfigured, may be used.

In addition, if a technology for forming an integrated circuit that replaces the LSI appears in accordance with the advancement of semiconductor technologies or other derivative technologies, naturally, the integration of the functional blocks may be performed by using such a technology. There may be a possibility of applications of bio technologies or the like.

The disclosure of Japanese Patent Application No. 2009-133308, filed on Jun. 2, 2009 and Japanese Patent Application No. 2009-235409, filed on Oct. 9, 2009, including the specification, drawings and abstract, is incorporated herein by reference in its entirety.

### INDUSTRIAL APPLICABILITY

A down-mixing device, an encoder, and methods therefor are useful for realizing high quantization performance in a case where a balance adjusting process according to balance weighting factors and a main component eliminating process are combined.

### REFERENCE SIGNS LIST

100 Encoder
101 Down-mixing section
102 Core encoder
103, 104, 105 MDCT section
106 Weighting factor quantizing section
107, 108, 604 Multiplication section
109, 110 Adder section
111, 112 Encoder
113 Multiplexing section
201, 202, 503 Power calculating section
203, 501, 502 Inner product calculating section
204, 504 Coefficient calculating section
205 M signal calculating section
301 ω calculating section
302 α/β calculating section
303 Coefficient storing section
505 Coefficient encoding section
506 Coefficient Decoding section
601 Vector calculating section
602 Matrix calculating section
603 Inverse matrix calculating section
605 Adjustment section
   606 Matching section

1. A down-mixing device that generates a monaural signal as an encoding target by using a first signal and a second signal that configure a stereo signal, the down-mixing device comprising:
a first power calculating section that receives the first signal and second signal as inputs and calculates first power of the first signal and second power of the second signal;
a first inner product calculating section that receives the first signal and the second signal as inputs and calculates a first inner product of the first signal and the second signal;
a coefficient calculating section that calculates a first coefficient and a second coefficient, by which a first cost function is minimized, by repeating calculations using a first calculation equation that uses the first coefficient and the second coefficient by which the first signal and the second signal are multiplied, respectively so as to calculate the first power, the second power, the first inner product, and the monaural signal, the first calculation equation being acquired by modifying the first cost function that is configured by the sum of power of a first difference signal relating to the first signal and power of a second difference signal relating to the second signal; and
a monaural signal calculating section that generates the monaural signal by adding results acquired by multiplying the first signal and the second signal by the first coefficient and the second coefficient, respectively.

2. The down-mixing device according to claim 1,
wherein the coefficient calculating section includes:
a first calculating section that calculates a third coefficient by using a second calculation equation that uses the first power, the second power, the first inner product, the first coefficient, and the second coefficient, the second calculation equation being acquired by modifying the cost function; and
a second calculating section that calculates the first coefficient and the second coefficient by applying the third coefficient to the first calculation equation, and
wherein the coefficient calculating section finally calculates the first coefficient and the second coefficient by the repeated calculations in which the calculation of the third coefficient by the first calculating section and the calculation of the first coefficient and the second coefficient by the second calculating section are alternately repeated a predetermined number of times.

3. The down-mixing device according to claim 1, wherein the monaural signal calculating section performs smoothing of the first coefficient and the second coefficient and generates the monaural signal by using the smoothed first coefficient and the smoothed second coefficient instead of the first coefficient and the second coefficient.

4. An encoder that encodes a first encoding target signal and a second encoding target signal generated so as to correspond to a first signal and a second signal that configure a stereo signal, and a monaural signal that is generated by using the first signal and the second signal, the encoder comprising:
the down-mixing device according to claim 1 that generates the monaural signal by performing a down-mixing process using the first signal and the second signal;
a monaural encoding section that generates a first code by encoding the monaural signal and generates a decoded monaural signal by decoding the first code;
a weighting factor quantizing section that generates a first balance weighting factor used to generate the first encoding target signal and a second balance weighting factor used to generate the second encoding target signal by using the first signal, the second signal, and the decoded monaural signal;
a first target generating section that generates the first encoding target signal by reducing the first signal by an amount of a result acquired by multiplying the decoded monaural signal by the first balance weighting factor; and
a second target generating section that generates the second encoding target signal by reducing the second signal by an amount of a result acquired by multiplying the decoded monaural signal by the second balance weighting factor.

5. The encoder according to claim 4, wherein the weighting factor quantizing section generates a weighting factor by using the first signal, the second signal, and the decoded monaural signal, generates a second code by encoding the weighting factor, generates an inverse quantization weighting factor by decoding the second code, and generates the first balance weighing factor by which the decoded monaural signal is multiplied so as to generate the first encoding target signal and the second balance weighing factor by which the decoded monaural signal is multiplied so as to generate the second encoding target signal by using the inverse quantization weighting coefficient.

6. The encoder according to claim 5, wherein the weighting factor quantizing section calculates a second inner product of the first signal and the decoded monaural signal, a third inner product of the second signal and the decoded monaural signal, and third power of the decoded monaural signal and calculates the weighting factor that minimizes a second cost function by using a third calculation equation that uses the second inner product, the third inner product, and the third power, the third calculation equation being acquired by modifying the second cost function configured by the sum of power of a third difference signal relating to the first signal and power of a fourth difference signal relating to the second signal.

7. The encoder according to claim 4, wherein the sum of the first balance weighting factor and the second balance weighting factor is a constant.

8. A down-mixing device that generates a monaural signal as an encoding target by using a first signal and a second signal that configure a stereo signal, the down-mixing device comprising:
a monaural signal generating section that generates the monaural signal by using a result acquired by calculating a calculation equation that is set by using the sum of the product of elements of the first signal and the product of elements of the second signal.

9. The down-mixing device according to claim 8,
wherein the monaural signal generating section includes:
a vector calculating section that calculates a third signal whose one element is the sum of the product of an element of a fixed number of the first signal and an element of a first number of the first signal and the product of an element of the fixed number of the second signal and an element of the first number of the second signal;
a matrix calculating section that calculates a matrix whose one element is the sum of the product of an element of a second number of the first signal and an element of the first number of the first signal and the product of an element of the second number of the second signal and an element of the first number of the second signal;
an inverse matrix calculating section that calculates an inverse matrix of the matrix; and
a multiplication section that generates the monaural signal by using a result acquired by multiplying the inverse matrix by the third signal together.

10. An encoder that encodes a first encoding target signal and a second encoding target signal generated so as to correspond to a first signal and a second signal that configure a stereo signal and a monaural signal that is generated by using the first signal and the second signal, the encoder comprising:
the down-mixing device according to claim 8 that generates the monaural signal by performing a down-mixing process using the first signal and the second signal;
a monaural encoding section that generates a first code by encoding the monaural signal and generates a decoded monaural signal by decoding the first code;
a weighting factor quantizing section that generates a first balance weighting factor used to generate the first encoding target signal and a second balance weighting factor used to generate the second encoding target signal by using the first signal, the second signal, and the decoded monaural signal;
a first target generating section that generates the first encoding target signal by reducing the first signal by an amount of a result acquired by multiplying the decoded monaural signal by the first balance weighting factor; and
a second target generating section that generates the second encoding target signal by reducing the second signal by an amount of a result acquired by multiplying the decoded monaural signal by the second balance weighting factor.

11. A down-mixing method that generates a monaural signal as an encoding target by using a first signal and a second signal that configure a stereo signal, the down-mixing method comprising:
accepting input of the first signal and second signal and calculating first power of the first signal and second power of the second signal;
accepting input of the first signal and the second signal and calculating the first inner product of the first signal and the second signal;
calculating a first coefficient and a second coefficient that minimize a first cost function by repeated calculations using a first calculation equation that uses the first coefficient and the second coefficient by which the first signal and the second signal are multiplied respectively so as to calculate the first power, the second power, the first inner product, and the monaural signal, the first calculation equation being acquired by modifying the first cost function that is configured by the sum of power of a first difference signal relating to the first signal and power of a second difference signal relating to the second signal; and
generating the monaural signal by adding results acquired by multiplying the first signal and the second signal by the first coefficient and the second coefficient, respectively.

12. A down-mixing method that generates a monaural signal as an encoding target by using a first signal and a second signal that configure a stereo signal, the down-mixing method comprising:
generating the monaural signal by using a result acquired by calculating a calculation equation that is set by using the sum of the product of elements of the first signal and the product of elements of the second signal.

13. An encoding method that encodes a first encoding target signal and a second encoding target signal generated so as to respectively correspond to a first signal and a second signal that configure a stereo signal and a monaural signal that is generated by using the first signal and the second signal, the encoder comprising:
generating the monaural signal by performing a down-mixing process using the first signal and the second signal according to the down-mixing method according to claim 11;
generating a first code by encoding the monaural signal and generating a decoded monaural signal by decoding the first code;
generating a first balance weighting factor used to generate the first encoding target signal and a second balance weighting factor used to generate the second encoding target signal by using the first signal, the second signal, and the decoded monaural signal;
generating the first encoding target signal by reducing the first signal by an amount of a result acquired by multiplying the decoded monaural signal by the first balance weighting factor; and
generating the second encoding target signal by reducing the second signal by an amount of a result acquired by multiplying the decoded monaural signal by the second balance weighting factor.
